(19) United States
(12) Patent Application Publication
(10) Pub. No.: US 2025/0050147 A1
(43) Pub. Date: Feb. 13, 2025

(54) ENHANCED AIRCRAFT FIRE PROTECTION SYSTEM

(71) Applicant: VALMIR POSSIDONIO DE SOUZA, Homestead, FL (US)

(72) Inventor: VALMIR POSSIDONIO DE SOUZA, Homestead, FL (US)

(21) Appl. No.: 18/231,397

(22) Filed: Aug. 8, 2023

(51) Int. Cl. A62C 3/08; A62C 99/00

(52) U.S. Cl. CPC A62C 3/08; A62C 99/0018

(57) ABSTRACT

The enhanced aircraft fire protection system comprises a fire suppression structure and an aircraft structure. The fire suppression structure is a mechanical structure used to extinguish uncontrolled combustion reactions that occur within the aircraft structure. Each instantiation selected from the plurality of the fire suppression instantiations provides fire suppression protection for a segregated space within the aircraft structure.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of fire prevention, containment or extinguishing adapted for vehicles. (A62C3/07)

### Summary of Invention

The enhanced aircraft fire protection system comprises a fire suppression structure and an aircraft structure. A plurality of instantiations of the fire suppression structure (hereinafter plurality of fire suppression instantiations) mount in the aircraft structure. The fire suppression structure is a mechanical structure used to extinguish uncontrolled combustion reactions that occur within the aircraft structure. Each instantiation selected from the plurality of the fire suppression instantiations provides fire suppression protection for a segregated space within the aircraft structure.

These together with additional objects, features and advantages of the enhanced aircraft fire protection system will be readily apparent to those of ordinary skill in the art upon reading the following detailed description of the presently preferred, but nonetheless illustrative, embodiments when taken in conjunction with the accompanying drawings.

In this respect, before explaining the current embodiments of the enhanced aircraft fire protection system in detail, it is to be understood that the enhanced aircraft fire protection system is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the enhanced aircraft fire protection system.

It is therefore important that the claims be regarded as including such equivalent construction insofar as they do not depart from the spirit and scope of the enhanced aircraft fire protection system. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a side view of an embodiment of the disclosure.

FIG. 2 is a reverse side view of an embodiment of the disclosure.

FIG. 3 is an end view of an embodiment of the disclosure.

FIG. 4 is an in-use view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

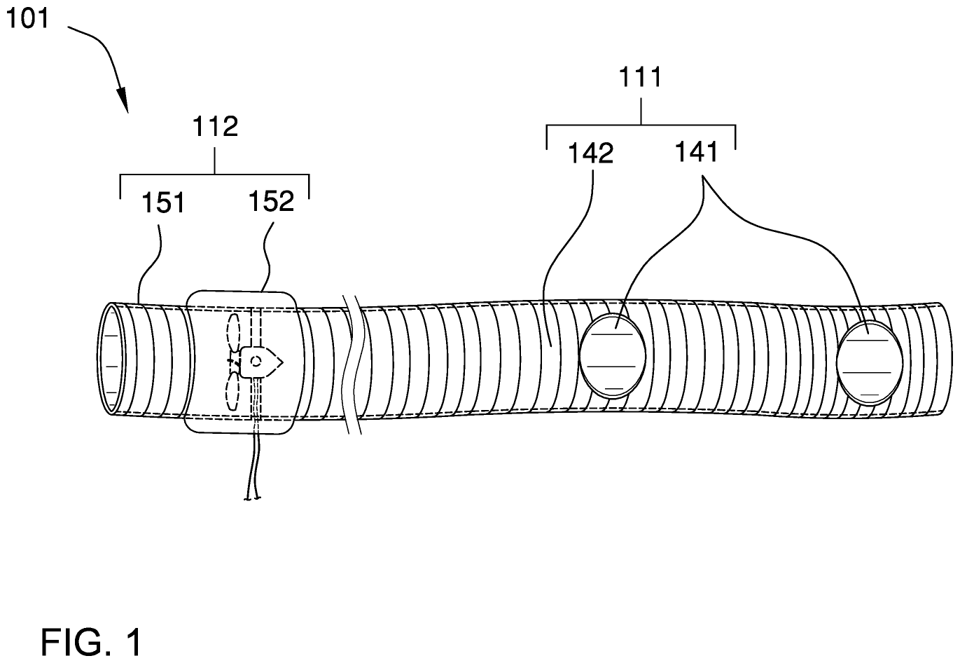

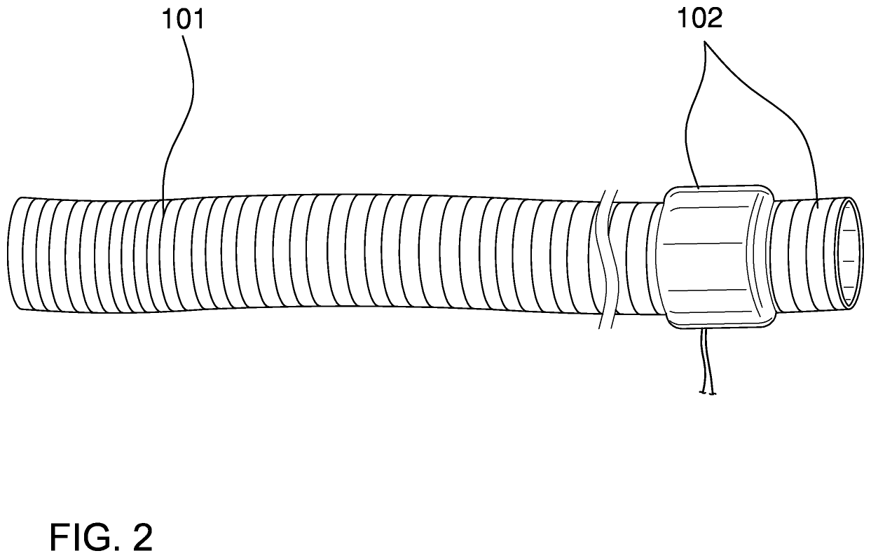

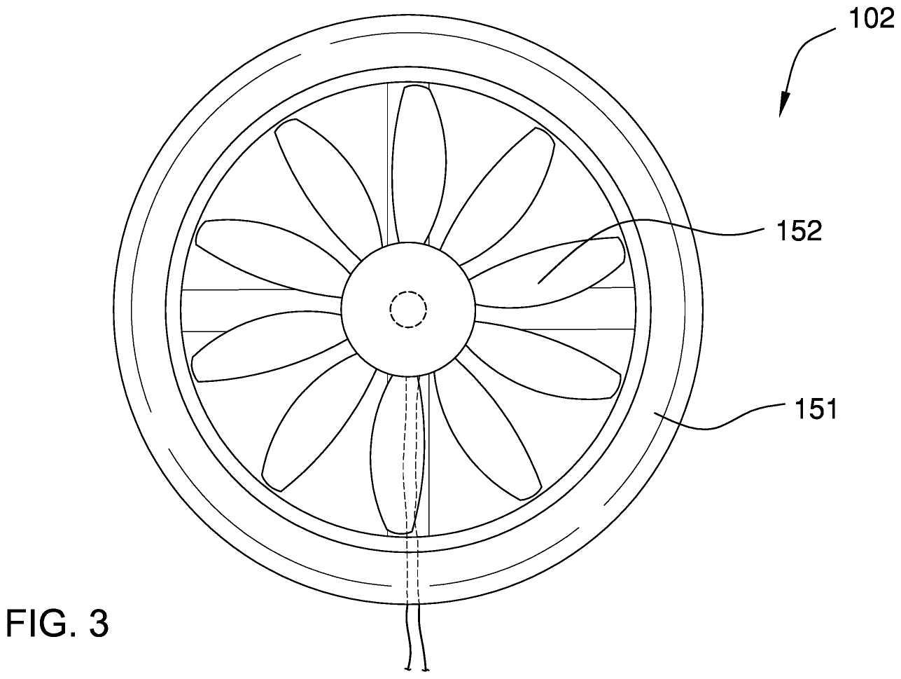

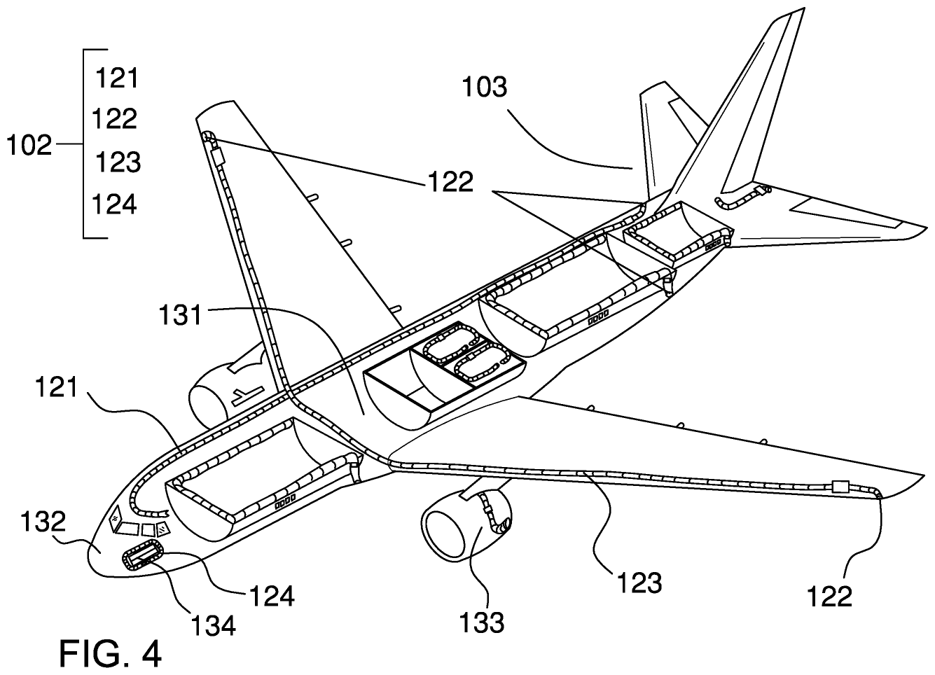

Detailed reference will now be made to one or more potential embodiments of the disclosure, which are illustrated in FIGS. 1 through 4.

The enhanced aircraft fire protection system 100 (hereinafter invention) comprises a fire suppression structure 101 and an aircraft structure 103. A plurality of instantiations of the fire suppression structures 101 (hereinafter plurality of fire suppression instantiations 102) mount in the aircraft structure 103. The fire suppression structure 101 is a mechanical structure used to extinguish uncontrolled combustion reactions that occur within the aircraft structure 103. Each instantiation selected from the plurality of the fire suppression instantiations 102 provides fire suppression protection for a segregated space within the aircraft structure 103.

The aircraft structure 103 is an aircraft. The aircraft is defined elsewhere in this disclosure. The aircraft structure 103 is formed with a plurality of interior chambers and interior housings. Each structure selected from the plurality of interior chambers and interior housings is an enclosed negative space. The invention 100 protects the plurality of interior chambers and interior housings from uncontrolled combustion reactions. The invention 100 protects the plurality of interior chambers and interior housings by removing the access of the uncontrolled combustion reaction to oxygen. The aircraft structure 103 comprises a passenger chamber 131, a cargo chamber 132, one or more engine housings 133, and a plurality of landing gear housings 134.

The passenger chamber 131 is a segregated space that is formed in the aircraft structure 103. The passenger chamber 131 is dedicated to the transport of passengers that are carried by the aircraft structure 103.

The cargo chamber 132 is a segregated space that is formed in the aircraft structure 103. The cargo chamber 132 is dedicated to the transport of cargo that is carried by the aircraft structure 103.

Each individual engine housing selected from the one or more engine housings 133 is a segregated space that is formed in the aircraft structure 103. Each selected individual engine housing is dedicated to housing an engine that provides the motive forces used to move the aircraft structure 103.

Each individual landing gear housing selected from the plurality of landing gear housings 134 is a segregated space that is formed in the aircraft structure 103. Each selected individual landing gear housing is dedicated to housing a landing gear structure that allows the aircraft structure 103 to move while on the ground.

The fire suppression structure 101 is a mechanical device. The fire suppression structure 101 is a fluid management device. The fire suppression structure 101 is an electrically powered device. The fire suppression structure 101 mounts in a negative space selected from the plurality of interior chambers and interior housings. The fire suppression structure 101 is associated with the selected negative space. The operation of fire suppression structure 101 is initiated by an externally provided fire detection device that detects the presence of an uncontrolled combustion reaction. Upon initiation, the fire suppression structure 101 generates a pressure differential that pumps the atmospheric gases out of the negative space that is associated with the fire suppression structure 101. The fire suppression structure 101 discharges the atmospheric gases removed from the associated negative space from the aircraft structure 103. The fire suppression structure 101 starves the uncontrolled combustion reaction of oxygen by removing that atmospheric gas from the associated negative space. The fire suppression structure 101 comprises a manifold structure 111 and a discharge structure 112.

The manifold structure 111 is a fluid transport structure. The manifold structure 111 forms a fluidic connection between a negative space selected from the plurality of interior chambers and interior housings and the discharge structure 112. The manifold structure 111 transports the evacuated atmospheric gas from the associated negative space to the discharge structure 112. The manifold structure 111 comprises a plurality of intake ports 141 and a plurality of transport structures 142.

Each intake port selected from the plurality of intake ports 141 is a fluid transport structure. Each selected intake port forms a fluidic connection between the associated negative space selected from the plurality of interior chambers and interior housings and a transport structure selected from the plurality of transport structures 142. Each selected intake port transports the evacuated atmospheric gas from the associated negative space to the selected transport structure when the associated fire suppression structure 101 is in operation.

Each transport structure selected from the plurality of transport structures 142 is a fluid transport structure. Each selected transport structure forms a fluidic connection between the plurality of intake ports 141 connected to the selected transport structure and the discharge pump structure 152 of the discharge structure 112. Each selected transport structure transports the evacuated atmospheric gas from the plurality of intake ports 141 to the discharge pump structure 152 when the associated fire suppression structure 101 is in operation.

The discharge structure 112 is a fluid transport structure. The discharge structure 112 forms a fluidic connection between a manifold structure 111 and the environment surrounding the aircraft structure 103. The discharge structure 112 discharges the evacuated atmospheric gas from the fire suppression structure 101 into the environment surrounding the aircraft structure 103. The discharge structure 112 physically generates the pressure differential that provides the motive forces that move the evacuated atmospheric gas through the fire suppression structure 101. Specifically, the discharge structure 112 draws the atmospheric gas out of the associated negative space into the manifold structure 111. The discharge structure 112 further pumps the evacuated atmospheric gas directly into the environment surrounding the aircraft structure 103. The discharge structure 112 comprises a discharge pipe 151 and a discharge pump structure 152.

The discharge pump structure 152 is a pump. The discharge pump structure 152 forms a fluidic connection between the plurality of transport structures 142 and the discharge pipe 151. The discharge pump structure 152 generates a pressure differential that the atmospheric gases out of the negative space that is associated with the fire suppression structure 101 into the plurality of intake ports 141 and the plurality of transport structures 142 when the fire suppression structure 101 is in operation. The discharge pump structure 152 draws the evacuated gas into the discharge pipe 151 and directly pumps the evacuated gas into the discharge pipe 151 for discharge.

The discharge pipe 151 forms a fluidic connection between the discharge pump structure 152 and the environment surrounding the aircraft structure 103. The discharge pipe 151 transports the evacuated atmospheric gas into the environment surrounding the aircraft structure 103.

Each instantiation selected from the plurality of fire suppression instantiations 102 is an instantiation of the fire suppression structure 101. Each instantiation selected from the plurality of fire suppression instantiations 102 mounts in a negative space selected from the plurality of interior chambers and interior housings. The selected instantiation is associated with the selected negative space. Each instantiation selected from the plurality of fire suppression instantiations 102 provides fire suppression services for its associated negative space. The plurality of fire suppression instantiations 102 comprises a passenger chamber 131 instantiation 121, a cargo chamber 132 instantiation 122, an engine chamber 133 instantiation 123, and a landing gear chamber 134 instantiation 124.

The passenger chamber 131 instantiation 121 is the instantiation selected from the plurality of fire suppression instantiations 102 that provides fire suppression services for the passenger chamber 131 of the aircraft structure 103.

The cargo chamber 132 instantiation 122 is the instantiation selected from the plurality of fire suppression instantiations 102 that provides fire suppression services for the cargo chamber 132 of the aircraft structure 103.

The engine chamber 133 instantiation 123 is the instantiation selected from the plurality of fire suppression instantiations 102 that provides fire suppression services for an individual engine housing selected from the one or more engine housings 133 of the aircraft structure 103. Each individual engine housing selected from the one or more engine housings 133 is associated with an instantiation selected from the plurality of fire suppression instantiations 102.

The landing gear chamber 134 instantiation 124 is the instantiation selected from the plurality of fire suppression instantiations 102 that provides fire suppression services for an individual landing gear housing selected from the plurality of landing gear housings 134 of the aircraft structure 103. Each individual landing gear housing selected from the plurality of landing gear housings 134 is associated with an instantiation selected from the plurality of fire suppression instantiations 102.

### Definitions and Directional References

Aircraft: As used in this disclosure, an aircraft is a vehicle that moves through the atmosphere (or a vacuum) without requiring a structural load path to a supporting surface.

Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.

Atmosphere: As used in this disclosure, the atmosphere refers to a blanket of gases (primarily nitrogen and oxygen) that surround the earth. Typical atmospheric conditions are approximated and characterized as the normal temperature and pressure. Atmospheric gases are commonly called air.

Auxiliary Power Unit: As used in this disclosure, an auxiliary power unit (abbreviated APU) is an independently powered and operated electric generator. The auxiliary power unit is mounted in a vehicle, such as an aircraft. The auxiliary power unit comprises a combustion engine and a generator. The auxiliary power unit provides electric energy for the vehicle in situations where the: a) the vehicle is not electrically connected to an external power source; and, b) the vehicle is not operating in the mode where the primary electric generation system is operating.

Barrier: As used in this disclosure, a barrier is a physical obstacle that forms a boundary between a first space and a second space. The barrier prevents the passage of an object between the first space and the second space.

Cant: As used in this disclosure, a cant is an angular deviation from one or more reference lines (or planes) such as a vertical line (or plane) or a horizontal line (or plane).

Cargo: As used in this disclosure, cargo refers to one or more objects that are intended to be transported using a vehicle. The term freight is a synonym for cargo.

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Chamber: As used in this disclosure, a chamber is an enclosed or enclosable negative space that is dedicated to a purpose.

Combustion: As used in this disclosure, combustion refers to a reduction-oxidation reaction wherein oxygen and a hydrocarbon are combined to release energy, carbon dioxide, and water. In general usage, the meaning of combustion is often extended to describe a reaction between oxygen and a fuel source, such as a hydrocarbon modified by functional groups, which releases energy.

Composite Prism: As used in this disclosure, a composite prism refers to a structure that is formed from a plurality of structures selected from the group consisting of a prism structure, a pyramid structure, and a spherical structure. The plurality of selected structures may or may not be truncated or bifurcated. The plurality of prism structures are joined together such that the center axes of each of the plurality of structures are aligned. The congruent ends of any two structures selected from the group consisting of a prism structure and a pyramid structure need not be geometrically similar.

Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.

Correspond: As used in this disclosure, the term correspond is used as a comparison between two or more objects wherein one or more properties shared by the two or more objects match, agree, or align within acceptable manufacturing tolerances.

Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.

Elevation: As used in this disclosure, elevation refers to the span of the distance in the superior direction between a specified horizontal surface and a reference horizontal surface. Unless the context of the disclosure suggest otherwise, the specified horizontal surface is the supporting surface the potential embodiment of the disclosure rests on. The infinitive form of elevation is to elevate.

Engine: As used in this disclosure, an engine is a device with moving parts that is used to convert energy into rotational or linear motion.

Environment: As used in this disclosure, an environment refers to the physical conditions surrounding an object. The term environment is often limited to the physical conditions that the object interacts with.

Exterior: As used in this disclosure, the exterior is used as a relational term that implies that an object is not contained within the boundary of a structure or a space.

Extinguish: As used in this disclosure, to extinguish means to cause a combustion reaction to come to an end.

Flow: As used in this disclosure, a flow refers to the passage of a fluid past a fixed point. This definition considers bulk solid materials as capable of flow.

Fluid: As used in this disclosure, a fluid refers to a state of matter wherein the matter is capable of flow and takes the shape of a container it is placed within. The term fluid commonly refers to a liquid or a gas.

Fluid Impermeable: As used in this disclosure, the term fluid impermeable refers to: a) the ability of a structure to not allow a fluid to pass through the structure; or, b) the ability of a material not absorb through the exterior surfaces of the material a fluid that the material is immersed in or exposed to.

Fluidic Connection: As used in this disclosure, a fluidic connection refers to a tubular structure that transports a fluid from a first object to a second object. Methods to design and use a fluidic connections are well-known and documented in the mechanical, chemical, and plumbing arts.

Fluid Network: As used in this disclosure, a fluid network refers to a transport structure that: a) receives a fluid into the fluid network; b) transports the fluid through a series of pipes, valves, and manifolds; and, c) discharges the fluid from the fluid network.

Force: As used in this disclosure, a force refers to a net (or unopposed) measurable interaction that changes the direction of motion of an object, the velocity of motion of an object, the momentum of an object, or the stress within an object. The term work refers to a measure of the amount of energy that is transferred through the application of a force over a distance. The term power refers to a measure of the amount of energy that is transferred over a period of time.

Force of Gravity: As used in this disclosure, the force of gravity refers to a vector that indicates the direction of the pull of gravity on an object at or near the surface of the earth.

Form Factor: As used in this disclosure, the term form factor refers to the size and shape of an object.

Gas: As used in this disclosure, a gas refers to a state (phase) of matter that is fluid and that fills the volume of the structure that contains it. Stated differently, the volume of a gas always equals the volume of its container.

Generator: In this disclosure, a generator is a machine that converts rotational mechanical energy into electric energy.

A generator typically comprises a stator and a rotor. The stator is a stationary hollow cylindrical structure that forms a magnetic field. The rotor is a rotating cylindrical structure that is coaxially mounted in the stator. The rotation of the rotor within the stator physically generates the electrical energy. A generator can generate an electrical voltage selected from the group consisting of an AC voltage and a DC voltage. When a DC voltage is generated, this disclosure assumes that the term generator includes commutator and electrical circuitry required to generate a regulated DC voltage.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1. By the term essentially geometrically similar is meant that the primary shapes of two objects are geometrically similar except that there are functional items (such as fastening devices) associated with the primary shape may not maintain the ratio for geometric similarity. By the term roughly geometrically similar is meant that the form factors between the primary shape of the two objects can vary by a factor of up to 10% when the two objects are normalized to be roughly geometrically identical.

Horizontal: As used in this disclosure, horizontal is a directional term that refers to a direction that is either: 1) parallel to the horizon; 2) perpendicular to the local force of gravity, or, 3) parallel to a supporting surface. In cases where the appropriate definition or definitions are not obvious, the second option should be used in interpreting the specification. Unless specifically noted in this disclosure, the horizontal direction is always perpendicular to the vertical direction.

Inferior: As used in this disclosure, the term inferior refers to a directional reference that is parallel to and in the same direction as the force of gravity when an object is positioned or used normally.

Interior: As used in this disclosure, the interior is used as a relational term that implies that an object is contained within the boundary of a structure or a space.

Instantiation: As used in this disclosure, an instantiation refers to a specific physical object or process that is created using a specification.

Jet: As used in this disclosure, a jet is a type of engine that generates a propulsive force through the continuous discharge of a pressurized fluid.

Liquid: As used in this disclosure, a liquid refers to a state (phase) of matter that is fluid and that maintains, for a given pressure, a fixed volume that is independent of the volume of the container.

Load: As used in this disclosure, the term load refers to an object upon which a force is acting or which is otherwise absorbing energy in some fashion. Examples of a load in this sense include, but are not limited to, a mass that is being moved a distance or an electrical circuit element that draws energy. The term load is also commonly used to refer to the forces that are applied to a stationary structure.

Load Path: As used in this disclosure, a load path refers to a chain of one or more structures that transfers a load generated by a raised structure or object to a foundation, supporting surface, or the earth.

Manifold: As used in this disclosure, a manifold is a pipe or chamber having several ports through which one or more fluids are gathered or distributed.

Negative Space: As used in this disclosure, negative space is a method of defining an object through the use of open or empty space as the definition of the object itself, or, through the use of open or empty space to describe the boundaries of an object.

One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction.

Pan: As used in this disclosure, a pan is a hollow and prism-shaped containment structure. The pan has a single open face. The open face of the pan is often, but not always, the superior face of the pan. The open face is a surface selected from the group consisting of: a) a congruent end of the prism structure that forms the pan; and, b) a lateral face of the prism structure that forms the pan. A semi-enclosed pan refers to a pan wherein the closed end of prism structure of the pan and/or a portion of the closed lateral faces of the pan are open.

Perimeter: As used in this disclosure, a perimeter is one or more curved or straight lines that bounds an enclosed area on a plane or surface. The perimeter of a circle is commonly referred to as a circumference.

Phase: As used in this disclosure, phase refers to the state of the form of matter. The common states of matter are solid, liquid, gas, and plasma.

Pressure: As used in this disclosure, pressure refers to a measure of force per unit area.

Primary Shape: As used in this disclosure, the primary shape refers to a description of the rough overall geometric shape of an object that is assembled from multiple components or surfaces. Use Roughly

Primary Structure: As used in this disclosure, a primary structure refers to the component of an object that the other components attach to. The primary structure is also called the base structure.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Protected Space: As used in this disclosure, a protected space is a negative space within which an object is stored. The protected space is enclosed by a barrier structure that: a) prevents damage to the object contained within the protected space; b) maintains conditions that are appropriate for the object; c) protects the object within the protected space from potential dangers that are outside of the protected space; or, d) maintains the privacy of the object within the protected space.

Pump: As used in this disclosure, a pump is a mechanical device that uses suction or pressure to raise or move fluids, compress fluids, or force a fluid into an inflatable object. Within this disclosure, a compressor refers to a pump that is dedicated to compressing a fluid or placing a fluid under pressure.

Reduction-Oxidation Reaction: As used in this disclosure, a reduction-oxidation reaction (also known as a redox reaction) is a chemical reaction involving the transfer of electrons between the reactants of the reaction.

Segregated Space: As used in this disclosure, a segregated space refers to a first negative space that does not overlap with a second negative space. By overlap is meant that that the first negative space and a second negative space do not share any common spaces. As a practical matter, when two negative spaces are formed such that a fluid will not flow between the two negative spaces, the two negative spaces can be considered segregated.

Solid: As used in this disclosure, a solid refers to a state (phase) of matter that: 1) has a fixed volume; and, 2) does not flow.

Superior: As used in this disclosure, the term superior refers to a directional reference that is parallel to and in the opposite direction of the force of gravity when an object is positioned or used normally.

Supporting Surface: As used in this disclosure, a supporting surface is a horizontal surface upon which an object is placed and to which the load of the object is transferred. This disclosure assumes that an object placed on the supporting surface is in an orientation that is appropriate for the normal or anticipated use of the object.

Tube: As used in this disclosure, the term tube is used to describe a hollow prism-shaped device with two congruent open ends. While tubes that are suitable for use in this disclosure are often used to transport or conveys fluids or gases, the purpose of the tubes in this disclosure are structural. In this disclosure, the terms inner dimension and outer dimension of a tube are used as they would be used by those skilled in the plumbing arts.

Vacuum: As used in this disclosure, vacuum is used to describe a first space that contains gas at a reduced gas pressure relative to the gas pressure of a second space. If the first space and the second space are connected together, this pressure differential will cause gas from the second space to move towards the first space until the pressure differential is eliminated.

Vehicle: As used in this disclosure, a vehicle is a motorized device that is used for transporting passengers, goods, or equipment. The term motorized vehicle refers to a vehicle can move under power provided by an electric motor or a combustion based engine. A motorized vehicle further comprises an electrical system that can be used as a source of electric energy. The enclosed passenger space of a vehicle is known as a cab.

Vertical: As used in this disclosure, vertical refers to a direction that is either: 1) perpendicular to the horizontal direction; 2) parallel to the local force of gravity; or, 3) when referring to an individual object the direction from the designated top of the individual object to the designated bottom of the individual object. In cases where the appropriate definition or definitions are not obvious, the second option should be used in interpreting the specification. Unless specifically noted in this disclosure, the vertical direction is always perpendicular to the horizontal direction.

With respect to the above description, it is to be realized that the optimum dimensional relationship for the various components of the invention described above and in FIGS. 1 through 4 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A fire suppression device for an aircraft cargo hold comprising
a fire suppression structure and an aircraft structure
wherein a plurality of instantiations of the fire suppression structures mount in the aircraft structure.

2. The fire suppression device for an aircraft cargo hold according to claim 1
wherein the fire suppression structure is a mechanical structure used to extinguish uncontrolled combustion reactions that occur within the aircraft structure;
wherein each instantiation selected from the plurality of the fire suppression instantiations provides fire suppression protection for a segregated space within the aircraft structure.

3. The fire suppression device for an aircraft cargo hold according to claim 2
wherein the aircraft structure is an aircraft;
wherein the aircraft structure is formed with a plurality of interior chambers and interior housings;
wherein each structure selected from the plurality of interior chambers and interior housings is an enclosed negative space;
wherein the fire suppression device for an aircraft cargo hold protects the plurality of interior chambers and interior housings from uncontrolled combustion reactions.

4. The fire suppression device for an aircraft cargo hold according to claim 3
wherein the aircraft structure comprises a passenger chamber, a cargo chamber, one or more engine housings, and a plurality of landing gear housings;
wherein the passenger chamber is a segregated space that is formed in the aircraft structure;
wherein the passenger chamber is dedicated to the transport of passengers that are carried by the aircraft structure;
wherein the cargo chamber is a segregated space that is formed in the aircraft structure;
wherein the cargo chamber is dedicated to the transport of cargo that is carried by the aircraft structure;
wherein each individual engine housing selected from the one or more engine housings is a segregated space that is formed in the aircraft structure;
wherein each selected individual engine housing is dedicated to housing an engine that provides the motive forces used to move the aircraft structure;
wherein each individual landing gear housing selected from the plurality of landing gear housings is a segregated space that is formed in the aircraft structure;
wherein each selected individual landing gear housing is dedicated to housing a landing gear structure that allows the aircraft structure to move while on the ground.

5. The fire suppression device for an aircraft cargo hold according to claim 4
wherein the fire suppression structure is a mechanical device;
wherein the fire suppression structure is a fluid management device;
wherein the fire suppression structure is an electrically powered device;
wherein the fire suppression structure mounts in a negative space selected from the plurality of interior chambers and interior housings;
wherein the fire suppression structure is associated with the selected negative space;
wherein the operation of fire suppression structure is initiated by an externally provided fire detection device that detects the presence of an uncontrolled combustion reaction;
wherein upon initiation, the fire suppression structure generates a pressure differential that pumps the atmospheric gases out of the negative space that is associated with the fire suppression structure;
wherein the fire suppression structure discharges the atmospheric gases removed from the associated negative space from the aircraft structure.

6. The fire suppression device for an aircraft cargo hold according to claim 5
wherein each instantiation selected from the plurality of fire suppression instantiations is an instantiation of the fire suppression structure;
wherein each instantiation selected from the plurality of fire suppression instantiations mounts in a negative space selected from the plurality of interior chambers and interior housings;
wherein the selected instantiation is associated with the selected negative space;
wherein each instantiation selected from the plurality of fire suppression instantiations provides fire suppression services for its associated negative space.

7. The fire suppression device for an aircraft cargo hold according to claim 6
wherein the fire suppression structure comprises a manifold structure and a discharge structure;
wherein the manifold structure forms a fluidic connection between a negative space selected from the plurality of interior chambers and interior housings and the discharge structure.

8. The fire suppression device for an aircraft cargo hold according to claim 7
wherein the manifold structure is a fluid transport structure;
wherein the manifold structure transports the evacuated atmospheric gas from the associated negative space to the discharge structure.

9. The fire suppression device for an aircraft cargo hold according to claim 8
wherein the discharge structure is a fluid transport structure;
wherein the discharge structure forms a fluidic connection between a manifold structure and the environment surrounding the aircraft structure;
wherein the discharge structure discharges the evacuated atmospheric gas from the fire suppression structure into the environment surrounding the aircraft structure;
wherein the discharge structure draws the atmospheric gas out of the associated negative space into the manifold structure;
wherein the discharge structure further pumps the evacuated atmospheric gas directly into the environment surrounding the aircraft structure.

10. The fire suppression device for an aircraft cargo hold according to claim 9
wherein the manifold structure comprises a plurality of intake ports and a plurality of transport structures;
wherein each selected intake port forms a fluidic connection between the associated negative space selected from the plurality of interior chambers and interior housings and a transport structure selected from the plurality of transport structures.

11. The fire suppression device for an aircraft cargo hold according to claim 10
wherein the discharge structure comprises a discharge pipe and a discharge pump structure;
wherein the discharge pump structure forms a fluidic connection between the plurality of transport structures and the discharge pipe.

12. The fire suppression device for an aircraft cargo hold according to claim 11
wherein each intake port selected from the plurality of intake ports is a fluid transport structure;
wherein each selected intake port transports the evacuated atmospheric gas from the associated negative space to the selected transport structure when the associated fire suppression structure is in operation;
wherein each transport structure selected from the plurality of transport structures is a fluid transport structure;
wherein each selected transport structure forms a fluidic connection between the plurality of intake ports connected to the selected transport structure and the discharge pump structure of the discharge structure;
wherein each selected transport structure transports the evacuated atmospheric gas from the plurality of intake ports to the discharge pump structure when the associated fire suppression structure is in operation.

13. The fire suppression device for an aircraft cargo hold according to claim 12
wherein the discharge pump structure is a pump;
wherein the discharge pump structure generates a pressure differential that the atmospheric gases out of the negative space that is associated with the fire suppression structure into the plurality of intake ports and the plurality of transport structures when the fire suppression structure is in operation;
wherein the discharge pump structure draws the evacuated gas into the discharge pipe and directly pumps the evacuated gas into the discharge pipe for discharge;
wherein the discharge pipe forms a fluidic connection between the discharge pump structure and the environment surrounding the aircraft structure;
wherein the discharge pipe transports the evacuated atmospheric gas into the environment surrounding the aircraft structure.

14. The fire suppression device for an aircraft cargo hold according to claim 12
wherein the plurality of fire suppression instantiations comprises a passenger chamber instantiation, a cargo chamber instantiation, an engine chamber instantiation, and a landing gear chamber instantiation;
wherein the passenger chamber instantiation is the instantiation selected from the plurality of fire suppression instantiations that provides fire suppression services for the passenger chamber of the aircraft structure;
wherein the cargo chamber instantiation is the instantiation selected from the plurality of fire suppression instantiations that provides fire suppression services for the cargo chamber of the aircraft structure;
wherein the engine chamber instantiation is the instantiation selected from the plurality of fire suppression instantiations that provides fire suppression services for an individual engine housing selected from the one or more engine housings of the aircraft structure;
wherein each individual engine housing selected from the one or more engine housings is associated with an instantiation selected from the plurality of fire suppression instantiations;
wherein the landing gear chamber instantiation is the instantiation selected from the plurality of fire suppression instantiations that provides fire suppression services for an individual landing gear housing selected from the plurality of landing gear housings of the aircraft structure;
wherein each individual landing gear housing selected from the plurality of landing gear housings is associated with an instantiation selected from the plurality of fire suppression instantiations.
